(19) United States
(12) Patent Application Publication
(10) Pub. No.: US 2007/0070960 A1
(43) Pub. Date: Mar. 29, 2007

(54) Device, system, and method of multi-entity wireless communication adapter having a multi-channel mode

(76) Inventors: Amit Barak, Haifa (IL); Yuval Bachrach, Haifa (IL); Marc Jalfon, Zichron Yaakov (IL)

Correspondence Address: PEARL COHEN ZEDEK LATZER, LLP, 1500 BROADWAY, 12TH FLOOR, NEW YORK, NY, 10036, US

(21) Appl. No.: 11/235,207

(22) Filed: Sep. 27, 2005

(51) Int. Cl. H04Q 7/24

(52) U.S. Cl. 370/338

(57) ABSTRACT

Embodiments of the present invention provide a method and apparatus for a multi-entity wireless communication adapter, including at least a first connection module to communicate a first signal traffic corresponding to a basic service set station entity, a second connection module to communicate a second signal traffic corresponding to an entity that is not a basic service set station, a shared physical layer to process both the first and the second signal traffics, and a media access controller to control communication of the first and second signal traffics via first and second communication channels, respectively, according to a channel management scheme. Additional features are described and claimed.

### BACKGROUND OF THE INVENTION

A conventional use case network may include concurrent local and personal area wireless networks. For example, a laptop or notebook computer may connect to, e.g., a wireless bridge or a remote printer, over a wireless local area network (WLAN) and to a peripheral device, e.g., a projector or a storage device, over a wireless personal area network (WPAN).

One method for implementing a concurrent wireless local and personal area network is to equip a device with two independent wireless adapters, which may operate according to the same wireless protocol or two different wireless protocols. For example, “IEEE Std 802.11, 1999 Edition (ISO/IEC 8802-11: 1999)” defines a set of standards for WLAN communication, and “IEEE Std 802.15.1-2002 defines a set of standards for WPAN communication. Using two independent adapters may involve doubling of physical resources such as, for example, baseband processors and/or radio frequency circuitry.

Another option is to utilize the same adapter for both WLAN and WPAN communication by allowing the user to manually switch between the two modes. For example, an 802.11 network interface card (NIC) may normally operate as part of a basic service set (BSS) in a ILAN, but may be manually switched to operate as part of an independent basic service set (IBSS) in a WPAN by allowing peer-to-peer communication. However, a manually switched adapter may only connect to one network, for example, either a WPAN or a WLAN, at any given time.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic illustration of a wireless communication system including one or more communication devices having a multi-entity adapter according to a demonstrative embodiment of the invention.

FIG. 2 is a schematic illustration of a part of a frequency band helpful in demonstrating use of a multi-channel mode according to a demonstrative embodiment of the invention.

FIG. 3 is a schematic illustration of a timing diagram helpful in demonstrating channel management of a multi-channel mode of a multi-entity adapter according to a demonstrative embodiment of the invention.

It will be appreciated that for simplicity and clarity of illustration, elements shown in the drawings have not necessarily been drawn accurately or to scale. For example, the dimensions of some of the elements may be exaggerated relative to other elements for clarity or several physical components included in one functional block or element. Further, where considered appropriate, reference numerals may be repeated among the drawings to indicate corresponding or analogous elements. Moreover, some of the blocks depicted in the drawings may be combined into a single function.

### DETAILED DESCRIPTION OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

It should be understood that the present invention may be used in a variety of applications. Although the present invention is not limited in this respect, the circuits and techniques disclosed herein may be used in many apparatuses such as personal computers, stations of a radio system, wireless communication system, digital communication system, satellite communication system, and the like.

Stations intended to be included within the scope of the present invention include, by way of example only, wireless local area network (WLAN) stations, wireless personal area network (WPAN) stations, two-way radio stations, digital system stations, analog system stations, cellular radiotelephone stations, and the like.

Types of WLAN communication systems intended to be within the scope of the present invention include, although are not limited to, “IEEE-Std 802.11, 1999 Edition (ISO/IEC 8802-11: 1999)” standard, and more particularly in “IEEE-Std 802.11b-1999 Supplement to 802.11-1999, Wireless LAN MAC and PHY specifications: Higher speed Physical Layer (PHY) extension in the 2.4 GHz band”, “IEEE-Std 802.11a-1999, Higher speed Physical Layer (PHY) extension in the 5 GHz band” standard, “IEEE P802.11 ma™/D1.0” draft standard, and the like.

Types of WLAN stations intended to be within the scope of the present invention include, although are not limited to, stations for receiving and transmitting spread spectrum signals such as, for example, Frequency Hopping Spread Spectrum (FHSS), Direct Sequence Spread Spectrum (DSSS), Orthogonal frequency-division multiplexing (OFDM) and the like.

Devices, systems and methods incorporating aspects of embodiments of the invention are also suitable for computer communication network applications, for example, intranet and Internet applications. Embodiments of the invention may be implemented in conjunction with hardware and/or software adapted to interact with a computer communication network, for example, a personal area network (PAN), local area network (LAN), wide area network (WAN), or a global communication network, for example, the Internet.

Some embodiments of the invention provide a method and apparatus for concurrent operation of multiple entities, e.g., a basic service set (BSS) station (STA) entity and an access point (AP) entity, substantially simultaneously over a shared baseband processor and radio frequency circuits. In a wireless communication system, it may be desirable for a device to maintain concurrent association and/or signal traffic with devices in both local and personal area networks. For example, it may be desirable to maintain concurrent association and/or signal traffic with an access point of a WLAN, i.e., to operate as a BSS STA entity, while maintaining concurrent association and/or traffic with peripheral devices, i.e., to operate as an IBSS STA entity or BSS AP entity of a WPAN or WLAN, respectively.

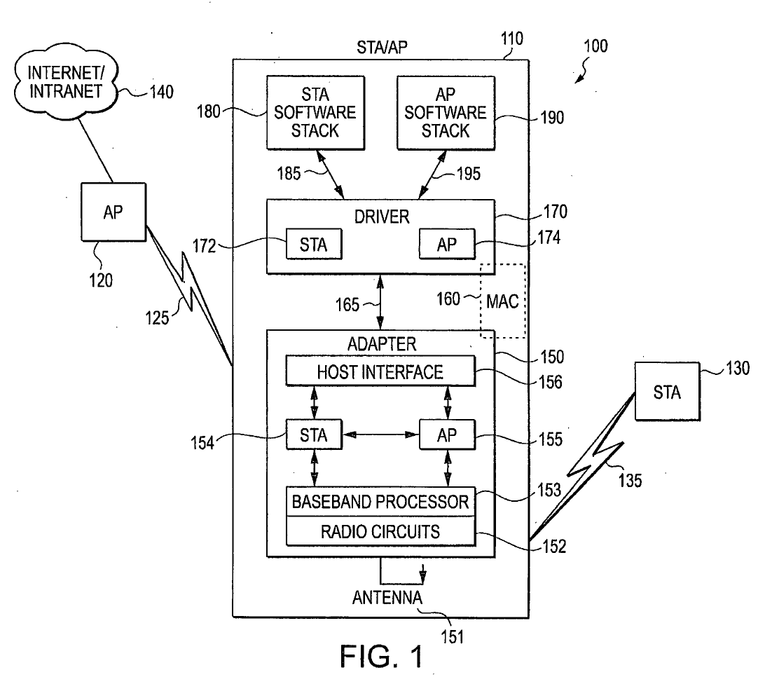

Reference is made to FIG. 1, which schematically illustrates a wireless communication system 100 including local area and personal area network elements in accordance with a demonstrative embodiment of the present invention. It will be appreciated by those skilled in the art that the simplified components schematically illustrated in FIG. 1 are intended for demonstration purposes only, and that other components may be required for operation of the wireless devices. Those of skill in the art will further note that the connection between components in a wireless device need not necessarily be exactly as depicted in the schematic diagram.

Although the invention is not limited in this respect, wireless communication system 100 may include at least one multi-entity device, for example, a dual-entity STA/AP device 110, an access point 120 of a wireless network 125, for example, a WLAN, and a peripheral station 130 of an additional network 135, for example, a WPAN. In accordance with embodiments of the invention, dual-entity STA/AP 110 may be able to maintain concurrent association and/or signal traffic with AP 120 over a link 125 of a WLAN 125, e.g., to operate as a BSS STA entity, while maintaining concurrent association and/or signal traffic with STA 130 over a link 135 of a WPAN 135, e.g., to operate as a BSS AP or IBSS STA entity. In addition, a plurality of dual-entity devices 110 may be in communication with one another and/or with a wider intranet or the Internet 140, e.g., via AP 120 over link 125 of a WLAN. The dual-entity devices 110 may also be in communication with one another via, e.g., link 135 of a WPAN.

Although the invention is not limited in this respect, dual-entity STA/AP 110 may include a STA entity software stack 180, an AP entity software stack 190, a driver 170, and a multi-entity adapter, e.g., a dual-entity adapter 150. Dual-entity adapter 150 may be associated with one or more radio frequency antennae 151, e.g., a dipole antenna, omnidirectional antenna, semi-omnidirectional antenna, or any other antenna suitable for transmission and/or reception of radio frequency signals. Software stacks 180 and 190 may mclude, e.g., software for implementing network protocols of the application layer, presentation layer, session layer, transport layer, and network layer of the seven-layer Open Systems Interconnection (OSI) reference model for network communication, as is known in the art. For example, a network application in STA stack 180 may generate data to be transmitted to a network application in intranet 140, via AP 120 over link 125, e.g., of a WLAN, and a network application in AP stack 190 may generate data to be transmitted to a network application in STA 130 over link 135, e.g., of a WPAN. In another example, AP software stack 190 may include networking software with routing capabilities to allow range extension of AP 120 or sharing of Internet connection 140. According to the appropriate network protocols, data packets 185 from stack 180 and data packets 195 from stack 190 may be transmitted to driver 170. In accordance with some demonstrative embodiments of the invention, during transmission driver 170 may provide an output in the form of data frames 165 to be further processed by adapter 150. During reception, driver 170 may receive data frames 165 from adapter 150 to be processed into data packets for software stacks 180 and 190.

According to some demonstrative embodiments of the invention, dual-entity STA/AP 110 may include a media access controller (MAC) 160. It will be appreciated by those skilled in the art that MAC 160 may include mechanisms to control data transfer, including, for example, to transmit and receive frames, to delimit frames, to check for errors, to insert headers with MAC addresses for routing, to route frames according to MAC addresses, and to control timing and/or permissions of transmit queues of data and management frames. MAC 160 may be implemented by any combination of hardware and/or software in different parts of STA/AP 110, for example, parts of driver 170 and/or adapter 150, as explained in detail below.

According to some demonstrative embodiments of the invention, driver 170 may include, for example, a STA upper MAC 172 to process data packets 185 and an AP upper MAC 174 to process data packets 195. For example, upper MAC 172 and 174 may be a higher layer MAC (HMAC) according to the 802.11 standards, as is known in the art. It will be appreciated by those skilled in the art that driver 170 perform tasks including, for example, translation of frames between different network protocols, or operations that are not timing-critical, such as rate scaling or reassembly of fragmented received frames. According to some demonstrative embodiments of the invention, upper MACs 172 and 174 may be implemented as separate modules or as components of the same module. In accordance with other demonstrative embodiments of the invention, the functionality of upper MACs 172 and 174 may be included in components of adapter 150.

According to some demonstrative embodiments of the invention, the multi-entity adapter, e.g., dual-entity adapter 150, may be capable of providing functionality for a STA entity, an AP entity, or concurrent STA/AP entity. In addition, the multi-entity adapter may be able to maintain concurrent association with multiple networks, e.g., an 802.11 WLAN, an 802.15 WPAN, and/or any other suitable network as is known in the art, and may be referred to as a multi-networks adapter. Dual-entity adapter 150 may include a STA connection module 154 and an AP connection module to control timing-critical MAC operations involved in reception and transmission of signal traffic of the respective entities, as explained in detail below. For example, connection modules 154 and 155 may provide functionality of a lower MAC, as it is known in the art. In accordance with embodiments of the invention, connection modules 154 and 155 may operate over a shared physical layer including baseband processor 153 and radio frequency circuits 152, as described in detail below.

Dual-entity adapter 150 may also include a host interface module 156 to provide interface between the driver and adapter. The host interface module may handle transfer of data and commands between driver 170 and connection modules 154 and 155. e.g. it may act as a bus master and initiate transactions over interface 165, or it may respond to transactions initiated by driver 170, in which case host interface module 156 may act as a bus target or slave. Although the invention is not limited in this respect, connection modules 154 and 155 may, e.g., facilitate transmitting and receiving of data signals to and from host interface 156 and the shared physical layer. In accordance with different demonstrative embodiments of the invention, STA connection module 154 and AP connection module 155 may be implemented using hardware, software, and/or any suitable combination of software and hardware, either within separate lower MACs or within the same lower MAC, and may also include additional functionality of MAC 160, for example, the non-timing critical functionality of upper MACs 172 and 174 described above.

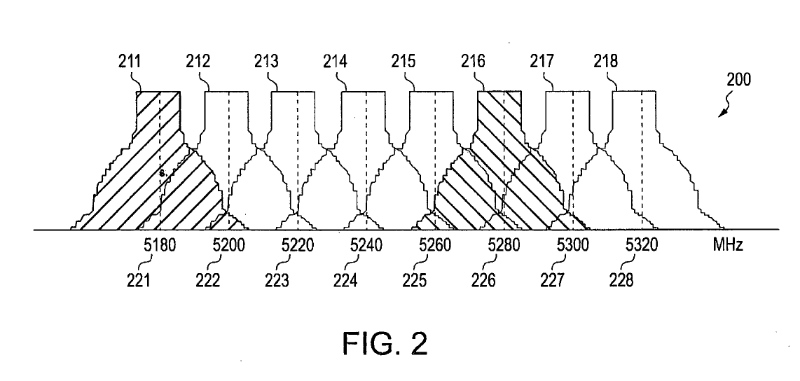

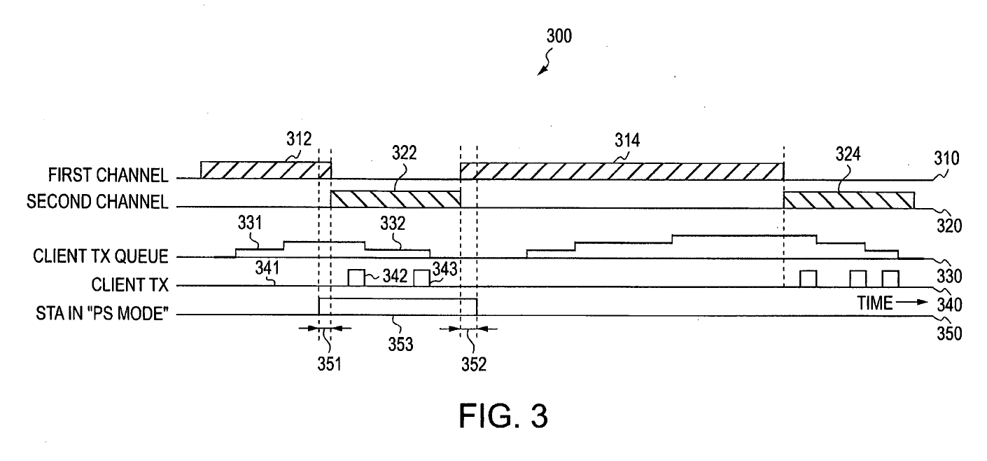

Although the invention is not limited in this respect, the multi-entity adapter, e.g., dual-entity adapter 150, may transmit and receive signal traffics, including management frames, e.g., beacons, probe requests, and probe responses; control frames, e.g., request-to-send (RTS) and clear-to-send (CTS); and data frames, e.g., broadcasts, multicasts, or unicasts; for an AP entity and a STA entity, which may be concurrently associated with a WLAN and a WPAN. For example, dual-entity adapter 150 may interleave STA and AP data and management frames 165 using the same baseband and radio components. The associated MAC 160 may control the timing of the STA and AP entities such that the STA entity may maintain connection and signal traffic with a network AP, e.g., AP 120, while the AP entity may send beacons and keep PAN client device, e.g., peripheral STA 130, associations and signal traffic active, as explained in detail below. In accordance with different embodiments of the invention, the multi-entity adapter may transmit and receive all frames on a single channel, or the adapter may transmit and receive signal traffic for the STA entity on one channel, and for the AP entity on a different channel, as is described in detail below with reference to FIG. 2 and FIG. 3.

Although the invention is not limited in this respect, during reception STA connection module 154 and AP connection module 155 may send a receive enable signal to the physical layer in order to activate the receiver parts of the physical layer, e.g., radio circuits 152 and baseband processor 153. Radio circuits 152 and baseband processor 153 may convert radio signals received via antenna 151, including, e.g., data frames for both the STA and AP entities of dual-entity communication device 110, into a digital data stream for further processing by connection modules 154 and 155. For example, connection modules 154 and 155 may perform lower MAC functions including for example, cyclic redundancy checks (CRC), transmission of acknowledgement frames, and MAC address filtering. According to demonstrative embodiments of the invention, connection modules 154 and 155 may, in addition, receive data. streams transmitted by other connection modules within the multi-entity adapter, in addition to receiving data streams from the physical layer.

Although the invention is not limited in this respect, during transmission host interface 156 may transmit data to connection modules 154 and 155, e.g., lower MACs, to be transmitted to the physical layer. It will be appreciated by those with skill in the art that, in accordance with network protocols, lower MACs 154 and 155 may wait for a clear channel indication, for example, reception of a clear channel assessment (CCA) signal from the physical layer, before transmitting. In accordance with embodiments of the invention, the CCA signal may be responsive to transmissions of one or more lower MAC modules within the multi-entity adapter. For example, a CCA signal entering module 155 may be a combination, e.g., a logical OR, of the CCA signal from the physical layer and a transmit indication from module 154. Similarly, a CCA signal entering module 154 may be a combination, e.g., a logical OR, of the CCA signal from the physical layer and a transmit indication from module 155. In addition, lower MAC modules 154 and 155 may handle aspects of the transmission flow such as, for example, handshake frames, acknowledgement frames, retransmission of frames, and request-to-send (RTS)—clear-to-send (CTS) conversation.

Although the invention is not limited in this respect, the multi-entity adapter, e.g., a multi-networks adapter, may associate and authenticate to an access point, e.g., AP 120 of a WLAN, and transfer data to and from the access point, as a STA entity. During that time it may also establish a BSS as an AP entity and allow other stations, e.g., STA 130 of a WPAN, to associate and authenticate to the BSS, and to transfer data to and from the AP upper and lower MACs 174 and 155, respectively. In accordance with embodiments of the invention, the multi-entity adapter may implement an AP, but may add or remove some features from a standard access point features list. For example, peripheral devices may connect to dual-entity adapter 150 even if they do not have access to WLAN infrastructure. Alternatively, dual-entity adapter 150 may also be configured to require infrastructure LAN access rights from peripherals. Access rights may be managed by AP lower MAC 155, AP upper MAC 174, AP software stack 190, or by a combination thereof.

Reference is made to FIG. 2, which illustrates part of a frequency band 200 helpful in demonstrating use of a multi-channel mode of a wireless communication adapter according to a demonstrative embodiment of the invention. A wireless communication adapter, e.g., a multi-entity adapter as described above with reference to FIG. 1, may be equipped to operate according to one or more wireless communication standards. For example, an adapter may be able to operate according to, e.g., the 802.11g or 802.11b standards using channels from the 2.4 GHz band, or according to, e.g., both the 802.11a and 802.11g standards using channels from the 5 GHz band and 2.4 GHz band, respectively. According to different demonstrative embodiments of the invention, the multi-entity adapter may be able to operate using multiple channels chosen from the 5 GHz band, the 2.4 GHz band, a combination of the 5 GHz and 2.4 GHz bands, or any other suitable radio frequency band as is known in the art. Although the present invention is not limited in this respect, radio frequency band 200, as illustrated, is a part of the 5 GHz band.

Radio frequency band 200 may include a plurality of channels, e.g., channels 211-218, to carry signal traffics of various entities, e.g., of a multi-entity adapter or any other suitable wireless communication device as is known in the art. Radio channels 211-218 may partially overlap, causing interference among neighboring channels. It will be appreciated that interference may be minimal at a center frequency of a channel, e.g., center frequencies 221-228 corresponding to channels 211-218, respectively.

Although the invention is not limited in this respect, a multi-entity adapter operating in multi-channel mode may scan for available channels, for example, in radio frequency band 200, e.g., using one or more antennae 151, radio circuits 152, and baseband processor 153 of FIG. 1. A multi-entity device equipped with a multi-channel adapter, e.g., dual-entity STA/AP 110 of FIG. 1, may allocate a first channel for signal traffic of a first entity and a second channel for signal traffic of a second entity, using, for example, driver 170, MAC 160, adapter 150, and components thereof such as, e.g., upper MAC modules 172 and 174 and lower MAC modules 154 and 155. For example, channel 211 may be allocated for signal traffic of a BSS STA entity and channel 216 may be allocated for signal traffic of an entity that is not a BSS STA entity, e.g., an IBSS STA entity or BSS AP entity. In accordance with some demonstrative embodiments of the invention, the first channel, e.g., channel 211, may carry signal traffic over a link of a WLAN and the second channel, e.g., channel 216, may carry signal traffic over a link of a WPAN. The multi-entity adapter may select available channels and switch channel frequencies according to techniques known in the art.

In accordance with some demonstrative embodiments of the invention, multi-channel mode of a multi-entity adapter may include automatic switching between the channels allocated for the different entities, e.g., channels 211 and 216 allocated for a STA entity and AP entity respectively, such that the adapter may operate in different channels at different times. Channel switching may be scheduled according to a predetermined channel management scheme such that the STA entity does not lose association a network access point, e.g., AP 120 of FIG. 1, and peripheral stations, e.g., STA 130 of FIG. 1, do not lose association with the AP entity of the multi-entity adapter. For example, according to some demonstrative embodiments of the invention, the channel management scheme may be controlled by a MAC, e.g., MAC 160 of FIG. 1, and the timing of the channel switching may be controlled by components such as, e.g., lower MAC connection modules 154 and 155 of FIG. 1. Although the invention is not limited in this respect, the channel management scheme may include periodic switching between the channels for the respective entities, as described below with reference to FIG. 3.

Although the invention is not limited in this respect, a network access point, e.g., AP 120 of FIG. 1, may be continuously associated with a channel and thus available to communicate signal traffic with an associated station device. In contrast, when operating in multi-channel mode, the AP entity of a multi-entity wireless communication device, e.g., dual-entity STA/AP 110 of FIG. 1, may be absent from its allocated channel, e.g., channel 211, at times when the multi-entity adapter processes signal traffic for the STA entity on a different channel, e.g., channel 216, using the same radio frequency circuits and baseband processor. For example, referring back to FIG. 1, AP connection module 155 may be unavailable to communicate signal traffic of the AP entity, e.g., to receive data signals from peripheral STA 130 over a channel associated with a WPAN, at times when the shared physical layer, including, e.g., baseband processor 153 and radio frequency circuits 152, and antenna 151 may be switched to a channel associated with a WLAN.

In accordance with demonstrative embodiments of the invention, multi-channel mode of a multi-entity wireless communication adapter may have advantages over a single channel mode in a network that includes a plurality of multi-entity wireless communication devices. For example, allocating a separate channel for the signal traffics of the respective entities may allow maximizing throughput of signal traffic for each entity. In accordance with embodiments of the invention, multi-channel mode of a multi-entity adapter may include mechanisms for channel management as described in detail below.

Reference is made to FIG. 3, which schematically illustrates a timing diagram 300 helpful in demonstrating channel management according to a demonstrative embodiment of the invention. Although the invention is not limited in this respect, a timeline 310 for a first channel, e.g., a STA channel, and a timeline 320 for a second channel, e.g., an AP channel, is illustrated. In accordance with some demonstrative embodiments of the invention, a multi-entity adapter operating in multi-channel mode, e.g., a dual channel mode, may automatically switch between communication of signal traffic on the first channel, e.g., during time periods 312 and 314, and communication of signal traffic on the second channel, e.g., during time periods 322 and 324. As illustrated in diagram 300, the time periods 312, 322, 314, 324 may not overlap and the corresponding entity of the multi-entity adapter may be absent from its allocated channel at times, as explained above.

According to some demonstrative embodiments of the invention, multi-channel mode may include transmission of a quiet element or quiet command, as it is known in the art, to manage channel usage, e.g., between AP entity of a multi-entity adapter and an associated client station. It will be appreciated that a quiet element, e.g., as defined in the 802.11h and/or similar wireless communication standards known in the art, may define a quiet period of a predetermined duration during which an associated client station, e.g., STA 130 of FIG. 1, may not transmit to the AP entity. In accordance with some demonstrative embodiments of the invention, the quiet periods may correspond to, e.g., time periods 312 and 314 during which the multi-entity adapter may switch to the STA channel. Although the invention is not limited in this respect, the quiet element may be transmitted periodically.

Although the invention is not limited in this respect, a client station may manage a transmission queue and delay pending transmissions of transmit data frames in response to receiving a quiet command. For example, a client queue timeline 330 and a client transmission timeline 340 are illustrated. In accordance with some demonstrative embodiments of the invention, the transmission queue may include an accumulation period 331 corresponding to the quiet period, e.g., time period 312, during which the client station may accumulate frames for transmission in the queue. For example, the queue may increase step-wise as data packets are readied for transmission and placed in the queue. As illustrated in the corresponding transmission timeline 340, the client station may not transmit any frames during time period 341 corresponding to the accumulation period 331.

According to some demonstrative embodiments of the invention, the client station may transmit queued data frames during times when the AP entity is available to receive signal traffic on its allocated channel, e.g., time period 322. Although the invention is not limited in this respect, the client's transmission queue may include a de-accumulation period 332, during which the queue may be emptied, e.g., step-wise, corresponding to transmission of data frames, e.g., at time periods 342 and 343. Similarly, the client station may re-accumulate frames in the transmission queue during a next quiet period, e.g., corresponding to time period 314, and transmit the frames from queue during, e.g., time period 324.

According to some demonstrative embodiments of the invention, multi-channel mode may utilize a power save (PS) mechanism, as it is known in the art, to manage channel usage between the STA entity of a multi-entity adapter and an associated network AP, e.g., AP 120 of FIG. 1. It will be appreciated by those of skill in the art that when a station is in PS mode, an associated AP may buffer pending data transmissions until the STA exits PS, for example, following a STA wakeup event such as, e.g., a delivery traffic indication message (DTIM). For example, a STA entity PS mode timeline 350 is illustrated.

Although the invention is not limited in this respect, the STA entity of a multi-entity adapter may indicate entry into PS mode slightly before the adapter switches to the AP channel and may indicate exit from power save mode slightly after switching back to the STA channel. It will be appreciated that the STA entity of a multi-entity adapter may need to be available to process signal traffic on its allocated channel, e.g., during time periods 312 and 314, in order to transmit PS indications to an associated network AP.

For example, the STA entity may indicate entry into PS mode during a first buffer time 351, e.g., part of time period 312; remain in PS mode for a duration 353, e.g., corresponding to time period 322 when the adapter may be switched to the AP channel; and exit PS mode during a second buffer time 352, e.g., part of time period 314. In accordance with some demonstrative embodiments of the invention, buffer times 351 and 352 may be sufficient to accommodate a random delay inherent in transmitting and receiving of signal traffic, e.g., 5 milliseconds. Further, entry time buffer 351 may ensure that the associated network AP begins to buffer pending transmissions before the multi-entity adapter switches to a different channel, and thus data frames intended for the STA entity may not be lost.

While the invention has been described with respect to a limited number of embodiments, it will be appreciated that many variations, modifications and other applications of the invention may be made. Embodiments of the present invention may include other apparatuses for performing the operations herein. Such apparatuses may integrate the elements discussed, or may comprise alternative components to carry out the same purpose. It will be appreciated by persons skilled in the art that the appended claims are intended to cover all such modifications and changes as fall within the true spirit of the invention.

What is claimed is:

1. A method comprising:
controlling at least first and second signal traffics to be communicated using a shared physical layer via first and second communication channels, respectively, according to a channel management scheme which is executable by a media access controller, wherein said first signal traffic corresponds to a basic service set station entity and said second signal traffic corresponds to an entity that is not a basic service set station.

2. The method of claim 1, wherein controlling said first and second signal traffics comprises switching said shared physical layer between said first and second channels according to said channel management scheme.

3. The method of claim 2, wherein switching comprises periodically switching between alternating first and second time periods in which said first and second signal traffics are processed via said shared physical layer, respectively.

4. The method of claim 3, wherein controlling comprises communicating a power save mode entry indication in said first signal traffic to indicate that said basic service set station entity is to enter power save mode for the duration of said second time period.

5. The method of claim 3, wherein controlling comprises communicating a quiet element in said second signal traffic to define a quiet period of said second signal traffic for the duration of said first time period.

6. The method of claim 1, comprising communicating said first communication channel over a link of a wireless local area network and communicating said second communication channel over a link of a wireless personal area network.

7. An apparatus comprising:
a multi-entity wireless communication adapter including at least a first connection module to communicate a first signal traffic corresponding to a basic service set station entity, a second connection module to communicate a second signal traffic corresponding to an entity that is not a basic service set station, a shared physical layer to process both said first and said second signal traffics, and a media access controller to control communication of said first and second signal traffics via first and second communication channels, respectively, according to a channel management scheme.

8. The apparatus of claim 7, wherein said multi-entity adapter comprises one or more components of said media access controller.

9. The apparatus of claim 8, wherein said media access controller is to periodically switch said shared physical layer between said first and second communication channels such that said first and second signal traffics are processed during alternating first and second time periods, respectively.

10. The apparatus of claim 9, wherein said first connection module is to communicate a power save mode entry indication said first signal traffic to indicate entry into power save mode for the duration of said second time period.

11. The apparatus of claim 9, wherein said second connection module is to communicate a quiet element in said second signal traffic to define a quiet period of said second signal traffic for the duration of said first time period.

12. The apparatus of claim 7, wherein said first communication channel is a wireless local area network channel and wherein said second communication channel is a wireless personal area network channel.

13. A wireless communication system comprising:
a multi-entity wireless communication device comprising:
an adapter including at least a first connection module to communicate a first signal traffic corresponding to a basic service set station entity, a second connection module to communicate a second signal traffic corresponding to an entity that is not a basic service set station, a shared physical layer to process both said first and said second signal traffics, and a media access controller to control communication of said first and second signal traffics via first and second communication channels, respectively, according to a channel management scheme; and
one or more dipole antennae to transmit and receive signals corresponding to said first and second signal traffics over said first and second communication channels, respectively.

14. A wireless communication system according to claim 13, comprising:
one or more additional wireless communication devices to communicate with said multi-entity wireless communication device over a link of a wireless communication network.

15. A wireless communication system according to claim 14, wherein said wireless communication network is a wireless local area network.

16. A wireless communication system according to claim 15, wherein at least one of said additional wireless communication devices is an access point of said wireless local area network, and wherein said first connection module is to communicate a power save mode entry indication in said first signal traffic to indicate entry into power save mode for the duration of said second time period.

17. A wireless communication system according to claim 16, wherein said access point is to buffer pending transmissions of said first signal traffic in response to said power save mode entry indication.

18. A wireless communication system according to claim 14, wherein said wireless communication network is a wireless personal area network.

19. A wireless communication system according to claim 18, wherein at least one of said additional wireless communication devices is a client station of said wireless personal are network, and wherein said second connection module is to communicate a quiet element to define a quiet period of said second signal traffic for the duration of said first time period.

20. A wireless communication system according to claim 19, wherein said client station is to queue pending data transmissions of said second signal traffic in response to said quiet element.

21. A wireless communication system according to claim 13, wherein said first communication channel is a wireless local area network channel and wherein said second communication channel is a wireless personal area network channel.

22. A wireless communication system according to claim 13, wherein said adapter comprises one or more components of said media access controller.
